(19) United States
(12) Patent Application Publication
(10) Pub. No.: US 2018/0017521 A1
(43) Pub. Date: Jan. 18, 2018

(54) Semiconductor-Based Gas Sensor Assembly for Detecting a Gas and Corresponding Production Method

(71) Applicant: Robert Bosch GmbH, Stuttgart (DE)

(72) Inventors: Denis Kunz, Untergruppenbach (DE); Martin Schreivogel, Stuttgart (DE)

(21) Appl. No.: 15/537,966

(22) PCT Filed: Dec. 10, 2015
(86) PCT No.: PCT/EP2015/079233

§ 371 Date: Jun. 20, 2017

(30) Foreign Application Priority Data
Dec. 22, 2014 (DE) 10 2014 226 816.8

(51) Int. Cl. G01N 27/414

(52) U.S. Cl. CPC G01N 27/4141

(57) ABSTRACT

A semiconductor-based gas sensor assembly for detecting a gas includes a gas-sensitive structure with a gas electrode, an electrode, and a dielectric layer, and also includes a readout transistor and a substrate. The dielectric layer is positioned between the gas electrode and the electrode, and is at least partially polarized. The readout transistor is positioned in or on the substrate, and includes a gate. The gas-sensitive structure is configured to form a capacitance that is coupled to the gate of the readout transistor.

The present invention relates to a semiconductor-based gas sensor assembly for detecting a gas and a corresponding production method.

### PRIOR ART

Gas sensors find diverse applications, a wide variety of physical and chemical measurement principles being used. In many areas of use, importance is increasingly being attached here to low costs, small structural size and low power consumption, with high demands being placed on the robustness of the gas sensors. Against this background, semiconductor-based components, in particular gas sensors, constitute an important alternative to electrochemical cells, for example.

Field effect transistors (FET) having chemosensitive gate regions are known from the literature.

DE 19849932 A1, DE 19814857 A1, WO 2005/075969 A1, DE 4239319 C2 and DE 19849932 A1 disclose so-called suspended gate FETs (SG-FETs). The latter relate to sensor concepts based on gas absorption and an associated change in potential or work function in the gate region of a FET. However, serious signal drifts may occur as a result of the direct spatial proximity of the electrode exposed to the gas and the relatively sensitive field effect transistor. Reasons for this may include structural changes in the materials used or the introduction of contaminants. This problem is avoided in part in the case of the suspended gate or charge coupled FET by the FET that is used for reading out the signal being buried below a passivation and thus being spatially separated from the gas. However, as a result of an air gap used between sensitive layer and corresponding electrode, a capacitance that forms in a corresponding gate stack becomes relatively low, as a result of which the gas signals are attenuated in particular to a great extent.

### DISCLOSURE OF THE INVENTION

The present invention provides a semiconductor-based gas sensor assembly for detecting a gas as claimed in claim 1 and a corresponding production method as claimed in claim 11.

The semiconductor-based gas sensor assembly described here makes it possible to achieve, in particular, a very high sensitivity with regard to gas detection. For this purpose, use is made of a gas-sensitive structure comprising a gas electrode, an electrode and an at least partly polarizable dielectric layer arranged between the gas electrode and the electrode, wherein a capacitance formed by the gas-sensitive structure is coupled to a gate of a read-out transistor, and the read-out sensor is arranged in or on a substrate. This may involve a transducer, in particular, which may be designed for detecting different gases, in particular in very low concentrations, through the use of suitable electrode materials.

The respective dependent claims relate to preferred developments.

### Advantages of the Invention

The present invention makes it possible that gases in harsh environments can be detected with high sensitivity in a low concentration range with a semiconductor-based gas sensor assembly producible in large numbers. This is achieved, in particular, by the “burying” of the sensitive read-out transistor, such that contaminations and signal drifts associated therewith are avoided. A particularly high sensitivity is achieved by the use of at least partly polarizable dielectric layers, in particular thin-film layers, in the gas-sensitive structure. Said layers may have permittivities that are approximately two orders of magnitude higher than those of customary gate materials from semiconductor technology, such as SiO₂ or Al₂O₃, such that the gate capacitance increases by precisely this factor and the resolution increases. Furthermore, the gas dependence of the capacitance of the gas-sensitive structure itself can be used given a suitable mode of operation. That is to say that not only does the gate dielectric, for example the polarizable dielectric layer, act as a passive insulation layer through which the applied field punches toward the channel region, but the permittivity that changes greatly in a field- or gas-dependent manner additionally affects the channel current.

In comparison with the suspended gate concept described in the prior art, this has the advantage, in particular, that no air gap is necessary. The air gap has the consequence that the capacitance formed by the gas-sensitive structure, also referred to as gate capacitance, is reduced and the transmission of the signal of absorbed gas species is impaired. Moreover, complex flip-chip mounting is not necessary during processing, such that a high integrability/miniaturizability of the sensor is ensured since flip-chip mounting presupposes a correspondingly large, “handlable” chip geometry, such that a miniaturization of the semiconductor-based gas sensor is possible only to a limited extent.

The present invention furthermore enables a stable measurement of different gases in particular in a very low concentration range (ppt to ppm). The stable measurements can be carried out in particular under harsh ambient conditions (−50° C. to 800° C.)

The concept underlying the present invention consists in achieving very high sensitivities by means of a combination of a gas-sensitive structure and a read-out transistor. This is realized in particular by the gas-sensitive structure, which is coupled to the gate of the “buried” read-out transistor, in particular of a field effect transistor. The special feature of the gas-sensitive structure is that the at least partly polarizable dielectric layer is used therein. That is to say a layer whose impedance or permittivity varies depending on the applied electric field. Examples of such materials are ferroelectrics, for example, which generally have very high permittivities. However, other dielectrics such as SiO₂, Si₃N₄ or Al₂O₃ are also appropriate for use at high temperatures (preferably greater than 250° C.). In this case, the polarization mechanism is then determined by mobile ions within the layers. The electrode materials are chosen such that a change in the potential or in the work function is established depending on the gas to be detected. Metals (for example platinum (Pt), gold (Au), silver (Ag) or copper (Cu)), conductive polymers or organic substances and conductive ceramics are appropriate for this purpose. If the sensitive material itself is not conductive, it can be combined with a porous or otherwise structured electrode.

The capacitance formed by the gas-sensitive structure is directly coupled to the gate of the read-out transistor. In comparison with other read-out methods, this has the advantage of a very high and low-noise sensitivity as a result of the direct amplification by the read-out transistor and the extremely short lead between the capacitance and the amplifying read-out transistor. In this case, it is possible to use various operating modes with an evaluation circuit connected downstream. By way of example, with a constant gate voltage, it is possible to evaluate the source-drain current of the read-out transistor depending on the applied atmosphere. Conversely, the gate voltage can be readjusted in such a way that the source-drain current remains constant. In both cases, the applied voltages can also be applied only in a pulsed fashion.

In accordance with one preferred development, the read-out transistor is buried below a passivation layer or is arranged on a side of the substrate facing away from the gas-sensitive structure. In other words, in the semiconductor-based gas sensor assembly described here, the read-out transistor does not come into direct contact with the gas to be detected or the capacitance of the structure described is coupled to the gate of a read-out transistor which itself is not exposed to the gas to be examined. That is to say that the read-out transistor is isolated from the gas to be detected. As a result, the read-out sensor is protected against contaminants, in particular.

In accordance with a further preferred development, the capacitance formed by the gas-sensitive structure is directly coupled to the gate of the read-out transistor. In this case, the sensitivity of a read-out transistor can be made directly dependent on the capacitance at the gate and high capacitances or gas-dependent capacitance changes can be detected.

In accordance with a further preferred development, the read-out transistor is a field effect transistor. This has the advantage that particularly small semiconductor-based gas sensor assemblies can be realized.

In accordance with a further preferred development, the at least partly polarizable dielectric layer comprises silicon dioxide (SiO₂), aluminum dioxide (Al₂O₃), hafnium oxide (HfO₂), tantalum oxide (Ta₂O₅), zirconium oxide (ZrO₂), nitrides, such as in particular silicon nitride (Si₃N₄), boron nitride (BN), carbides, such as in particular silicon carbide (SiC), and silicides, such as in particular tungsten silicide (WSi₂), tantalum silicide (TaSi₂), and ferroelectric materials such as, for example, barium titanate (BaTiO₃), lead zirconate titanate (Pb(ZrₓTi₁₋ₓ)O₃) or barium strontium titanate (BaₓSr₁₋ₓTiO₃). In this development, in particular, it is possible to form an effective electrically insulating or polarizable dielectric layer which is furthermore suitable for being polarizable at least in a locally delimited manner. The abovementioned substances are sufficiently inert, in particular, such that polarizable species can be introduced into them and furthermore can also be present alongside one another without significant interactions under the operating conditions of the gas-sensitive structure. Consequently, the gas electrode, the electrode and the at least partly polarizable dielectric layer arranged between the gas electrode and the electrode form a capacitance structure which can serve as a basis for the semiconductor-based gas sensor assembly according to the invention.

Furthermore, the at least partly polarizable dielectric layer can be locally polarizable. That can mean for the purposes of the present invention, in particular, that the entire polarizable dielectric layer is polarizable, or that the polarizable dielectric layer is also polarizable only to a locally delimited extent and may have for instance dipoles aligned or alignable in a parallel fashion, or that a certain degree of polarity may be generatable in the layer at least in a spatially delimited manner. In this case, a polarizability can be understood to mean, in principle, the alignment of electrical charges or dipoles for a polarizability at the atomic or molecular level. This leads to a voltage-dependent permittivity of the at least partly polarizable dielectric layer.

In accordance with one preferred development, the gas electrode and the electrode comprise platinum (Pt), palladium (Pd), gold (Au), silver (Ag), rhodium (Rh), rhenium (Re), ruthenium (Ru), iridium (Ir), titanium (Ti), titanium nitride (TiN), tantalum nitride (TaN), copper (Cu) or alloys comprising one or more of the abovementioned components or conductive polymers and/or organic substances and conductive ceramics. In this case, the gas electrode and/or the electrode can be completely produced from one or more of the abovementioned substances or only partly comprise such substances, for instance in the form of particles arranged in an electrode structure.

In accordance with one preferred development, the gas electrode and the electrode are combinable with porous and/or structured further electrodes. Furthermore, conductive polymers and/or organic substances and conductive ceramics are appropriate. In this case, the combination has the advantage that, in particular, material costs can be saved if the sensitive or conductive material itself is not conductive. That is to say that the entire gas electrode and/or electrode need not comprise a cost-intensive material.

In accordance with one preferred development, the gas-sensitive structure is arranged on a membrane with or without an integrated heater. Advantageously, a fast response time and/or a low power consumption can be ensured as a result.

In accordance with one preferred development, the second electrode has an interdigital structure. The interdigital structure can simplify processing and makes it possible to apply a non-conductive, gas-sensitive gas electrode to that side of the dielectric, that is to say of the at least partly polarizable dielectric layer, which faces the gas.

In accordance with a further preferred development, the semiconductor-based gas sensor assembly is operable in a gate voltage range in such a way that dipoles are mobile in the at least partly polarizable dielectric layer, that is to say that a permittivity can vary as a result of absorbed gases. In order then to be able to read out this change, besides a DC bias a for example sinusoidally modulated voltage component must be applied to the gate. Said voltage component can have a constant or variable frequency. In order to achieve the case of mobile dipoles described here, in particular the static electric field can vanish in the at least partly polarizable dielectric layer, that is to say that very low gate voltages are employed under certain circumstances. In this case, the use of so-called normally on transistor architectures may be advantageous in order that sufficiently large channel currents can already be realized even at these gate voltages.

### BRIEF DESCRIPTION OF THE DRAWINGS

Further features and advantages of the present invention are explained below on the basis of embodiments with reference to the figures.

In the figures:

FIG. 1 shows a schematic perpendicular cross-sectional view for elucidating a semiconductor-based gas sensor assembly for detecting a gas and a corresponding production method in accordance with a first embodiment of the present invention;

FIG. 2 shows a schematic perpendicular cross-sectional view for elucidating a semiconductor-based gas sensor assembly for detecting a gas and a corresponding production method in accordance with a second embodiment of the present invention.

### EMBODIMENTS OF THE INVENTION

In the figures, identical reference signs designate identical or functionally identical elements.

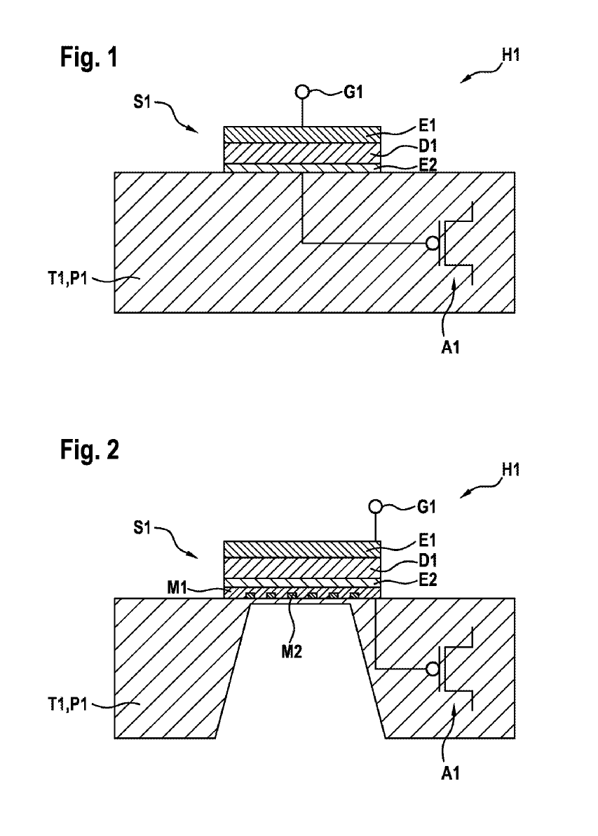

FIG. 1 shows a schematic perpendicular cross-sectional view for elucidating a semiconductor-based gas sensor assembly for detecting a gas and a corresponding production method in accordance with a first embodiment of the present invention.

In FIG. 1, reference sign H1 denotes a semiconductor-based gas sensor assembly for detecting a gas. The semiconductor-based gas sensor assembly H1 comprises a gas-sensitive structure S1 comprising a gas electrode E1, an electrode E2 and an at least partly polarizable dielectric layer D1 arranged between the gas electrode E1 and the electrode E2. The gas-sensitive structure S1 is suitable for forming a capacitance during operation. Said capacitance of the gas-sensitive structure S1 is coupled to a gate G1 of a read-out sensor A1 and the read-out sensor A1 is situated in a substrate T1.

As shown in FIG. 1, in contrast to the suspended gate concept, there is no need for an air gap that reduces the gate capacitance and impairs the transmission of the signal from the gas-sensitive structure. As shown in FIG. 1, the gas-sensitive structure S1 is in direct contact with the substrate T1, wherein the electrode E2 is in direct contact with the substrate T1. Alternatively, the read-out transistor Al can also be buried in a passivation layer P1.

In FIG. 1, the capacitance formed by the gas-sensitive structure S1 is directly coupled to the gate G1 of the read-out transistor A1.

FIG. 2 shows a schematic perpendicular cross-sectional view for elucidating a semiconductor-based gas sensor assembly for detecting a gas and a corresponding production method in accordance with a second embodiment of the present invention.

FIG. 2 shows the semiconductor-based gas sensor assembly H1 from FIG. 1 with the difference that the gas-sensitive structure S1 from FIG. 1 is arranged on a membrane M1 with an integrated heater M2. Furthermore, as shown in FIG. 2, a cutout is formed in the substrate T1 or the passivation layer P1 in the region of the gas-sensitive structure. In this case, the cutout is situated below the gas-sensitive structure S1 and is formed in the substrate T1 or the passivation layer P1. The cutout advantageously serves the purpose that the membrane is heated particularly rapidly by the integrated heating element on account of a thermal mass that is as small as possible, since a heat generated by the heating element does not have to be additionally emitted into or onto the substrate. Furthermore, the cutout is formed in such a way that the heat generated during operation can be rapidly dissipated toward the outside by the integrated heater M2 of the membrane M1, and rapid cooling after the end of operation is also possible.

In FIG. 2, the capacitance formed by the gas-sensitive structure S1 is coupled to the gate G1 of the read-out transistor A1, wherein the read-out transistor A1 is situated completely in the substrate and is arranged laterally with respect to the cutout in the substrate T1 or in the passivation layer P1.

As in FIG. 1, no air gap is formed in the exemplary embodiment in FIG. 2, as already described above.

Although the present invention has been described on the basis of preferred exemplary embodiments, it is not restricted thereto. In particular, the stated materials and topologies are merely by way of example and not restricted to the examples explained.

1. A semiconductor-based gas sensor assembly for detecting a gas, comprising:
a gas-sensitive structure that includes:
a gas electrode;
an electrode; and
an at least partly polarizable dielectric layer positioned between the gas electrode and the electrode;
a substrate; and
a read-out transistor that is positioned in or on the substrate and that includes a gate, wherein the gas-sensitive structure is configured to form a capacitance coupled to the gate of the read-out transistor.

2. The semiconductor-based gas sensor assembly as claimed in claim 1, wherein either (i) the assembly further comprises a passivation layer, and the read-out transistor is buried below the passivation layer, or (ii) the read-out transistor is positioned on a side of the substrate facing away from the gas-sensitive structure.

3. The semiconductor-based gas sensor assembly as claimed in claim 1, wherein the capacitance formed by the gas-sensitive structure is directly coupled to the gate of the read-out transistor.

4. The semiconductor-based gas sensor assembly as claimed in claim 1, wherein the read-out transistor is a field effect transistor.

5. The semiconductor-based gas sensor assembly as claimed in claim 1, wherein the at least partly polarizable dielectric layer includes silicon dioxide (SiO2), aluminum dioxide (Al2O3), hafnium oxide (HfO2), tantalum oxide (Ta2O5), zirconium oxide (ZrO2), nitrides, carbides, silicides, and ferroelectric materials.

6. The semiconductor-based gas sensor assembly as claimed in claim 1, wherein the gas electrode and the electrode in each case include at least one of:
(i) a component selected from a group consisting of platinum (Pt), palladium (Pd), gold (Au), silver (Ag), rhodium (Rh), rhenium (Re), ruthenium (Ru), iridium (Ir), titanium (Ti), titanium nitride (TiN), tantalum nitride (TaN), copper (Cu) or an alloy having one or more components selected from the group;
(ii) a conductive polymer;
(iii) an organic substance; and
(iv) a conductive ceramic.

7. The semiconductor-based gas sensor assembly as claimed in claim 1, wherein the gas electrode and the electrode are configured to combine with at least one of a further porous electrode and a further structured electrode.

8. The semiconductor-based gas sensor assembly as claimed in claim 1, further comprising a membrane that either includes or fails to include an integrated heater, wherein the gas-sensitive structure is positioned on the membrane.

9. The semiconductor-based gas sensor assembly as claimed in claim 1, wherein the second electrode has an interdigital structure.

10. The semiconductor-based gas sensor assembly as claimed in claim 1, wherein the semiconductor-based gas sensor assembly is operable in a gate voltage range such that dipoles are mobile in the at least partly polarizable dielectric layer.

11. A method of producing a semiconductor-based gas sensor assembly for detecting a gas, comprising:
positioning an at least partly polarizable dielectric layer between a gas electrode and an electrode to form a gas-sensitive structure;
coupling a capacitance formed by the gas-sensitive structure to a gate of a read-out transistor; and
positioning the read-out transistor in or on a substrate.

12. The semiconductor-based gas sensor assembly as claimed in claim 5, wherein:
the nitrides include at least one of silicon nitride (Si3N4) and boron nitride (BN);
the carbides include silicon carbide (SiC);
the silicides include at least one of tungsten silicide (WSi2) and tantalum silicide (TaSi2); and
the ferroelectric materials include at least one of barium titanate (BaTiO3), lead zirconate titanate (Pb(ZrxTi1-x)O3) and barium strontium titanate (BaxSr1-xTiO₃).
